(19) United States
(12) Patent Application Publication
(10) Pub. No.: US 2014/0311035 A1
(43) Pub. Date: Oct. 23, 2014

(54) SLIDING DOOR ASSEMBLY AND METHOD

(71) Applicant: TITUS GILLIAM, Nampa, ID (US)

(72) Inventor: TITUS GILLIAM, Nampa, ID (US)

(21) Appl. No.: 13/868,305

(22) Filed: Apr. 23, 2013

(51) Int. Cl. E05D 15/06; E06B 3/46

(52) U.S. Cl. CPC E05D 15/0643; E06B 3/4636; E05D 15/0652
USPC 49/410; 49/425; 49/506

(57) ABSTRACT

A sliding door assembly is disclosed with guide rail and rollers attached to a door. The rollers have bevels on both sides of a center portion, and fit into a single piece guide rail with three sections. Also disclosed is a method for making the sliding door assembly and installing it. In the method, a long, flat piece is bent in two places parallel to its long axis to form a guide rail with three sections.

### TECHNICAL FIELD

The presently disclosed and claimed inventive concepts generally relate to an apparatus for sliding doors, and more particularly to rail and roller mechanisms allowing a door to slide sideways to open or close a doorway.

### BACKGROUND

Sliding doors have been common in certain situations, including sliding glass doors, sliding barn doors, sliding pocket doors, and other applications. Sliding doors in the interior of housing has become a popular feature of current house design, for function and decorative purposes. Sliding doors allow for a door to be suspended from the door frame or wall and slide from side to side rather than swinging in or out from the closed position on hinges. By utilizing movable sliding door structures, the door can move along a horizontal track mounted at the top of the door opening. Sliding doors are useful for closets, pantries and other areas where a door is desirable but using swinging doors are not an option due to issues such as limited space.

While often a better option than swinging doors, sliding doors have several disadvantages. One disadvantage is the tendency of the roller to come off of the track. Attempts have been made to prevent this, such as putting another rail above the roller, but these attempts also created additional problems. One example of the added problems is the difficulty involved in removing or replacing the door on the track and the problem of getting the door back on the track.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

The current invention redesigns the traditional rail/roller system common with sliding door systems. In all embodiments, the invention is a sliding door assembly that allows for a door to be suspended from a wall or the frame of the door opening. The sliding door assembly includes a guide rail mounted to the door frame above the door opening and a roller assembly where the roller fits into the guide rail on a roller engaging profile, to provide support and guidance to the suspended door and allow the door to move in a side-to-side direction.

In one embodiment the sliding door assembly includes a guide rail designed to engage with bevels formed on the sides of the rollers. In this embodiment the rollers are formed such that the roller has a flat section in the middle of the roller and an angled bevel on each side of the flat section. In use, only the roller bevels are in contact with the trough. The guide rail of the present invention preferably a single piece of metal that has been bent into the desired guide rail shape. The guide rail has a flat section allowing for mounting the guide rail to the wall and a trough section for the placement of the roller.

Typical track hardware kits are limited to mounting points at exactly 16″ centers or continuous solid structural headers. The present track can span 24″ in the center of the track without a mounting lag screw required. Other track kits also require significant clearance over the top of the door for mounting the track and rollers. The disclosed track only required 3″ of clearance due to the single piece track of the design.

Other embodiment are also possible, all based on these characteristics:
The guide rail is used over the door (track is not a channel below door)
The roller is contained and guided by a mirror image of roller in track (other tracks use a flat bar with a steel grooved roller, box track fully encompassing roller but no channel, rod or wire that roller rolls on, or hexagon bar that roller rolls on).
The guide rail is matched to the roller.
The guide rail is a one piece unit for attaching to wall, with stand-off for creating a separating distance from the wall, and a guide for the roller built into the guide rail (all other tracks have multiple pieces to achieve all these separate functions). This makes the disclosed guide rail stronger, stiffer, easier to install, safer, simpler to manufacture—because the guide rail serves a number of different purposes in one unit. It provides strength, support, clearance and guides in all X, Y, and Z directions.

A method for making the guide rail and the sliding door assembly is also disclosed. The method begins with folding a long piece of generally rectangular metal. The metal piece is folded or bent in at least three positions along its long axis. The three folds of the guide rail form a first section for attachment to a wall, a second section extending out from the wall, and a third section which with the second section forms a trough, V, or round channel in which the rollers run. In one embodiment the rollers have a recessed inner channel circumferentially around the roller, which engages a raised V shape in the guide rail.

The next step is attaching the guide rail to a wall above a doorway. The method further comprises the step of attaching a generally planar bracket to the exterior of a door, with the upper end of the planar bracket extending above the top of the door. The next step is attaching at least two roller axles to the portion of the planar bracket extending above the top of the door. The next step is attaching rollers to the roller axles, and then placing the door on the guide rail.

### BRIEF DESCRIPTION OF THE DRAWINGS

FIG. 1 is an end view of an embodiment showing the sliding door assembly.

FIG. 2 is a planar view of the sliding door assembly.

FIG. 3 is a perspective view of the sliding door assembly.

FIG. 4 is a side view of an embodiment showing the sliding door assembly.

FIG. 5 is a side view of an embodiment showing the sliding door assembly.

FIG. 6 is a side view of an embodiment showing the sliding door assembly.

FIG. 7 is a side view of an embodiment showing the sliding door assembly.

FIG. 8 is a side view of an embodiment showing the sliding door assembly.

FIG. 9 is a side view of an embodiment showing the sliding door assembly.

FIG. 10 is a perspective view of the metal sheet that begins the process of making the guide rail.

FIG. 11 is a perspective view of the metal sheet folded to form the guide rail.

FIG. 12 is a view of the planar bracket, roller axle, and roller attached to the door.

### DETAILED DESCRIPTION OF THE EXEMPLARY EMBODIMENTS

While the presently disclosed inventive concepts are susceptible of various modifications and alternative constructions, certain illustrated embodiments thereof have been shown in the drawings and will be described below in detail. It should be understood, however, that there is no intention to limit the inventive concepts to the specific form disclosed, but, on the contrary, the presently disclosed and claimed inventive concepts is to cover all modifications, alternative constructions, and equivalents falling within the spirit and scope of the inventive concept(s) as defined in the claims.

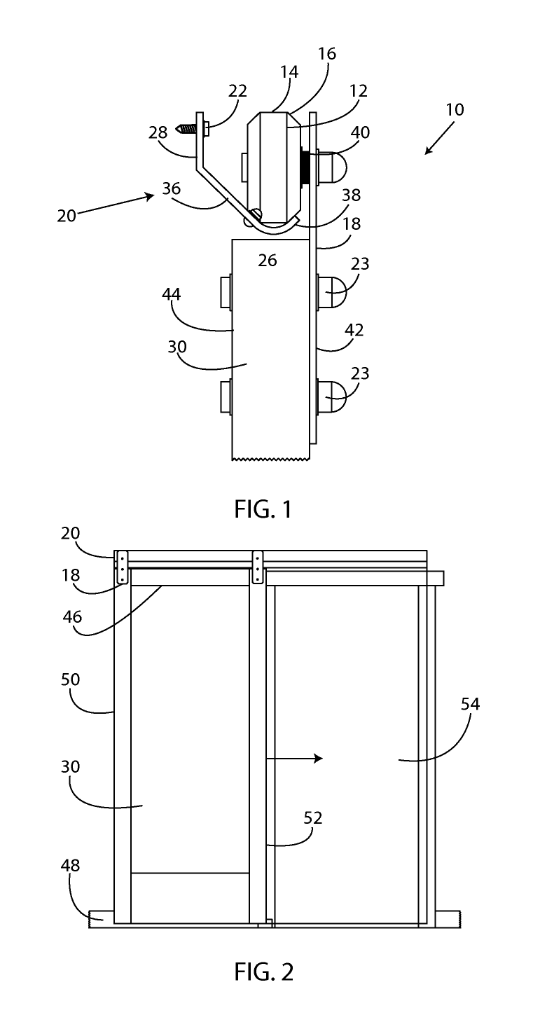

FIG. 1 illustrates a side cutaway view of a sliding door assembly 10 in accordance with the presently disclosed and claimed inventive concepts. Guide rail 20 is attached to the door frame, wall, or to a dropped beam from the ceiling, by wall mounting lag screw 22. Guide rail 20 is, preferably, made from a long flat metal piece which has been bent to have a first section 28, a second section 36, and a third section 38. Formed between the second section 28 and the third section 38 is a trough 26, which can be v shaped, or have a rounded bottom portion. First section 28 also has holes to accept wall mounting lag screws 22 for attaching the guide rail to the wall. Wall mounting lag screws 22 are placed through the holes in first section 28 and into the wall or door frame, securing the guide rail 20 to the wall, to a dropped beam from the ceiling, or to the door frame. Trough section 26 incorporates a hole at both ends of the guide rail to secure roller travel stop 24 to define the extent of side to side travel of the door 30 in the guide rail.

Roller 12 has circumferential area 14 and bevels 16. The circumferential area 14 can be flat, but other shapes such as convex or concave can be utilized. In one embodiment the roller the circumferential area 14 does not contact the trough 26. In a preferred design, bevels 16 are the only portion of the roller 12 that contacts the trough 26. Bevels 16 are preferably flat but can be of other designs complementary to the shape of trough 26. The roller 12 can have a convex or concave circumferential area.

A generally planar bracket 18 is attached to the upper end of the door 30 by door mounting bolts 23, which may penetrate the door or may not penetrate the door. Holes are in the bracket 18 provided for roller axles 40 to be attached to the generally planar bracket 18.

Shown in FIG. 1 is the door front side 42, and back side 44

FIG. 2 show a plan view of the door 30 on the guide rail 20, with the door 30 being slidable to cover or open the doorway 42. Shown are the door 30 top edge 46, bottom edge 48, left side 50, and right side 52.

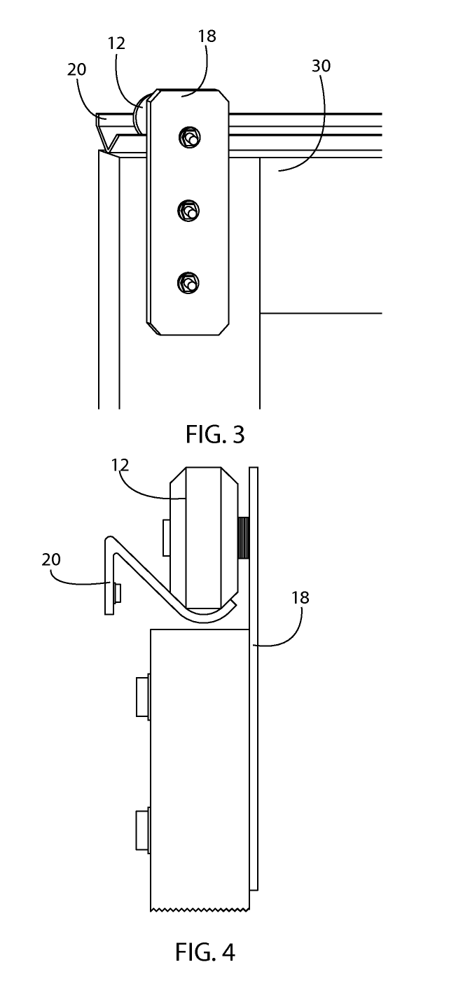

FIG. 3 shows a view of the roller 12 attached to the bracket 18, in the guide rail 20.

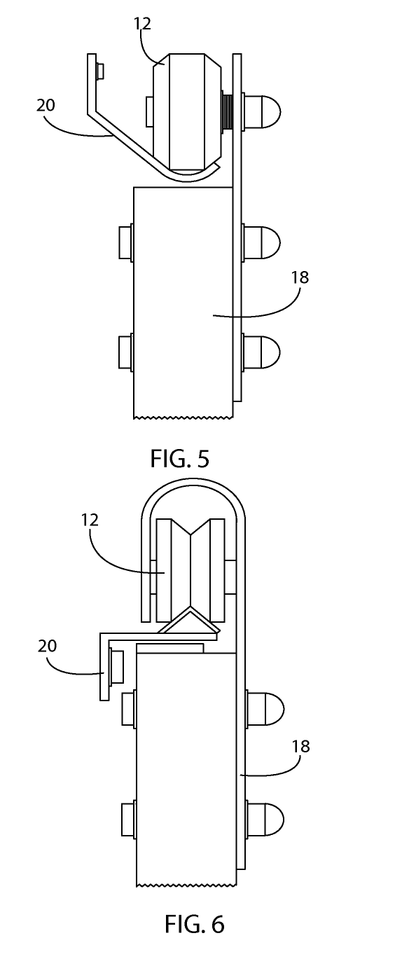

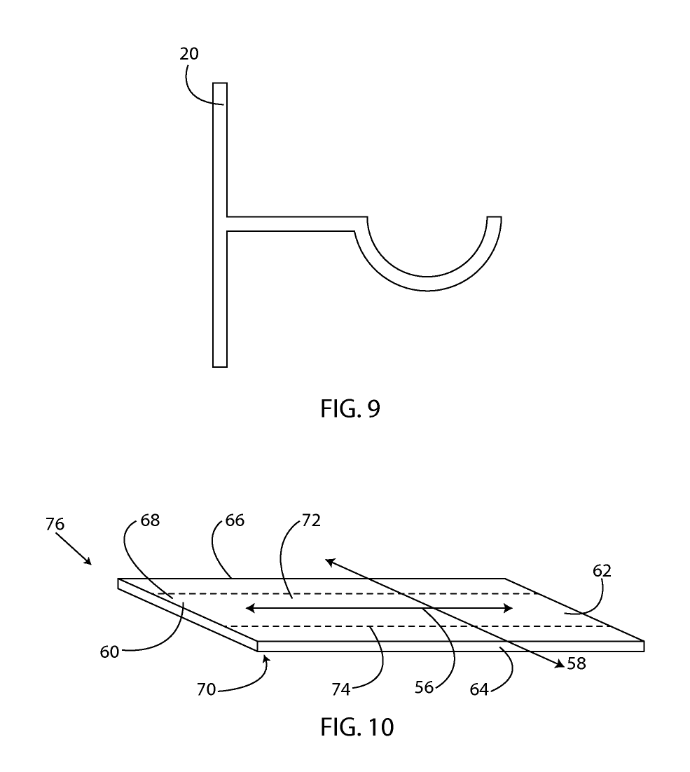

FIGS. 4, 5, 6, 7, 8 and 9 show alternate configurations of the guide rail 20, with complementary rollers 12, brackets 18, mounted on doors 30.

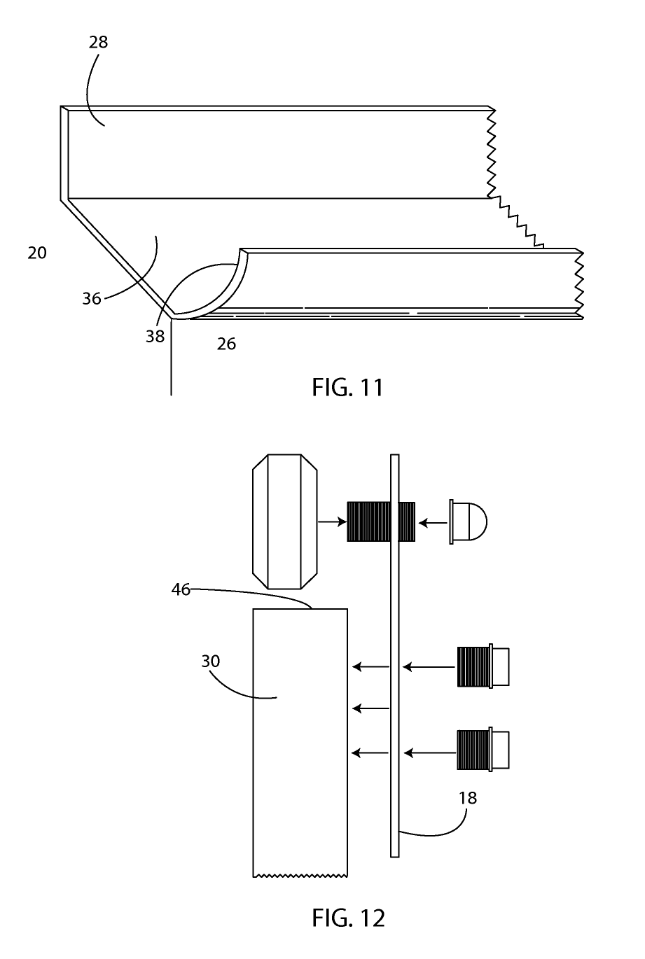

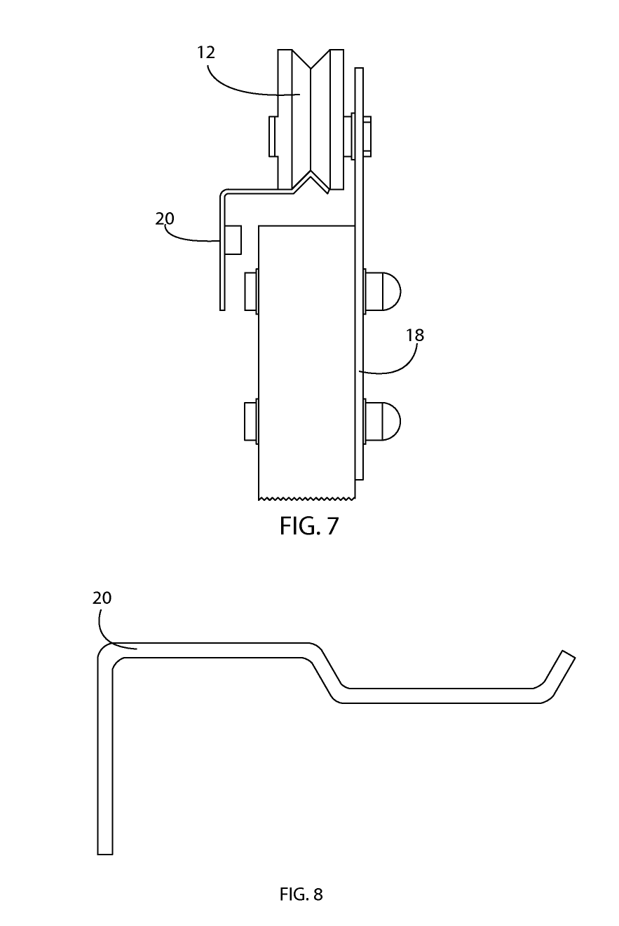

FIG. 10-12 show the metal sheet which begins the method of making and installing the sliding door assembly. Shown is the metal sheet 76, which has a long axis 56, a short axis 58, a first end 60, a second end 62, a front side 64, a back wall mounting side 66, a first face 68, a second face 70, and a first fold line 72 and second fold line 74.

The method of making and installing the disclosed sliding door assembly includes providing a generally rectangular metal sheet 76 with a long axis 56 and a short axis 58, and a first end 60, a second end 62, a front side 64, a back wall mounting side 66, a first face 68 and a second face 70, bending the metal sheet along the first and second fold lines 72 and 74, to form a guide rail 20 with a first section 28, a second section 36, and a third section 38 with a trough 26 between the second and third sections, attaching a generally planar bracket 18 to a door 30 with a portion of the bracket extending above the door top edge 46, attaching at least two roller axles 40 to the planar bracket 18, attaching at least two rollers 12 to the roller axles 40, attaching the first section 28 the rail guide 20 to a position above a doorway 54, and placing the door 30 with rollers 12 in the rail guide 20.

Note that a single planar bracket 18 could have more than one roller and roller axle.

While certain exemplary embodiments are shown in the Figures and described in this disclosure, it is to be distinctly understood that the presently disclosed inventive concepts are not limited thereto but may be variously embodied to practice within the scope of the following claims. From the foregoing description, it will be apparent that various changes may be made without departing from the spirit and scope of the disclosure as defined by the following claims.

What is claimed is:

1. A sliding door assembly for hanging a generally rectangular door on a wall above a door opening, said door having a front side, a back side, a top edge, a bottom edge, and a left side and a right side, said apparatus comprising:
a generally planar bracket attached to said front side of said door parallel to a plane of said door, near said top edge of said door and extending past said top edge of said door;
at least two roller axles attached to said planar bracket and oriented generally normal to a plane of said bracket;
at least two rollers mounted on said at least two roller axles;
a guide rail attached to said wall, said guide rail having a first section configured for attachment to said wall, and a second section extending generally outward at an angle from said first section, and a third section attached to said second section and having a roller engaging profile; wherein
said at least two rollers are configured to move on said roller engaging profile and thus allow said door to be moved sideways to cover or open said door opening.

2. The sliding door assembly of claim 1 in which said roller engaging profile is a trough in said third section of said guide rail which supports said rollers and which includes an upward extending outer rim for keeping said rollers on said roller engaging profile.

3. The sliding door assembly of claim 1 in which said roller engaging profile is a V shaped ridge on which said rollers fit, with said rollers having a v shaped center groove.

4. The sliding door assembly of claim 1 in which said rollers comprise bevels on each side of said rollers, with a flat spot between said bevels for engaging said roller engaging profile.

5. The sliding door assembly of claim 4 in which said guide rail comprises a three sided guide rail attached to said wall, said guide rail having a first section configured for attachment to said wall, and a second section extending generally downwardly and at an angle from said first section, and a third section attached to and extending upward at an angle from said second section, said third and second sections forming a trough at their intersection, said trough configured to engage said bevels of said rollers on said second and said third sections.

6. The sliding door assembly of claim 5 wherein said guide rail forms a generally v shaped trough to accept said rollers, with said bevels engaging sides of said v shaped trough.

7. The sliding door assembly of claim 1 wherein said guide rail forms a curved trough to accept said roller.

8. The sliding door assembly of claim 1 in which said planar bracket includes a curved portion which arches over the top of the door, with the roller axles supported on both ends by the planar bracket parallel with the door outer surface, and by the curved portion of the planar bracket.

9. Sliding door assembly of claim 1 wherein said guide rail further comprises a roller travel stop at both ends.

10. A sliding door assembly for hanging a generally rectangular door on a wall above a door opening, said door having a front side, a back side, a top edge, a bottom edge, and a left side and a right side, said apparatus comprising:
a three sided guide rail attached to said wall, said guide rail having a first section configured for attachment to said wall, and a second section extending generally downwardly and at an angle from said first section, and a third section attached to and extending upward at an angle from said second section, said third and second sections forming a trough at their intersection, said trough configured to engage bevels of rollers on said second and said third sections;
a generally planar bracket attached to said front side of said door parallel to a plane of said door, near said top edge of said door;
at least two roller axles attached to said planar bracket and oriented generally normal to a plane of said bracket;
at least two rollers mounted on said at least two roller axles, said rollers comprising bevels on each side of said rollers, with a flat spot between said bevels for engaging said roller engaging profile; wherein
at least two rollers are configured to move on said roller engaging profile and thus allow said door to be moved sideways to cover or open a door opening.

11. Sliding door assembly of claim 10 wherein said guide rail further comprises a roller travel stop at both ends.

12. A method of making a sliding door assembly comprising:
providing a generally rectangular metal sheet with a long axis and a short axis, and a first end, a second end, a front side, a back wall mounting side, a first face and a second face, and a first and second fold line;
bending the metal sheet along said first and second fold lines to form a guide rail with a first section, a second section, and a third section with a trough formed between said second and third sections;
attaching a generally planar bracket to a door with a portion of said bracket extending above said door top edge, attaching at least two roller axles to said planar bracket;
attaching at least two rollers to said roller axles;
attaching said first section of said guide rail to a position above a doorway; and
placing said door with rollers in said rail guide.
